(19) United States
(12) Patent Application Publication
(10) Pub. No.: US 2004/0093384 A1
(43) Pub. Date: May 13, 2004

(54) Method of, and system for, processing email in particular to detect unsolicited bulk email

(76) Inventor: Alex Shipp, Gloucester (GB)

Correspondence Address: Nixon & Vanderhye, 8th Floor, 1100 North Glebe Road, Arlington, VA, 22201-4714, US

(21) Appl. No.: 10/469,842

(22) PCT Filed: Mar. 4, 2002
(86) PCT No.: PCT/GB02/00926

(30) Foreign Application Priority Data
Mar. 5, 2001 (GB) 0105375.0

(51) Int. Cl. G06F 15/16; G06F 15/173

(52) U.S. Cl. 709/206; 709/224

(57) ABSTRACT

In order to alleviate problems caused by delivery of unwanted or unsolicited email (spam), email traffic is analysed for patterns of traffic which indicate or suggest that the emails are spam; when the system detects a pattern it thinks is spam it can take remedial action, e.g. blocking delivery of the emails involved, either itself or to a human operator. Analysis of email takes place by scanning a database of data abstracted from emails. These data are primarily abstracted from the emails when regarded as “containers” (i.e. without reference to the message contents).

The present invention relates to a method of, and system for, processing email in particular to detect unwanted or unsolicited bulk email (UBE) including, but not limited to, unwanted or unsolicited commercial email (UCE) and mail bombs.

A typical UCE or UBE consists of tens, hundreds, thousands or more copies of the same, or very similar email sent to multiple destinations. A large percentage may then bounce back because the recipient's email address no longer exists (or never existed). Due to the nature of the task, the original emails are not generated individually by hand, but by a software package. This package typically mailmerges an email with an address list and then sends out the emails. By no means all UBE is commercial, it includes religious and similar polemic. On the other hand, there are many legitimate uses of bulk email, e.g. so-called “list servers”.

A typical mail bomb consists of many copies of the same or similar emails sent to one email address, or one domain. Due to the nature of the task, these emails are generated by a package. These emails may saturate the recipient's email facilities and so may be regarded as a “denial of service” attack.

From here, all unwanted mail (UCE, Mailbomb, etc) will be referred to as spam.

The enjoyment and usefulness of email is harmed by the increasing amount of spam.

A variety of techniques have been used to reduce the problem of spam. For example, an ISP (or end user) may use software that implements “spam filters”. These may employ textual analysis of the email body, or strategies such as determining whether the email comes from a “blacklisted” source (there are a number of on-line Internet services which maintain blacklists, such as ORBS, RSS and DUL).

A known technique for stopping mailbombs is to count emails as they arrive at a certain destination, and block delivery of them once a threshold is reached.

In our copending British Patent Application No. 0016835.1, filed Jul. 7, 2000, we propose a system for looking for, and acting upon, traffic patterns that indicate, or suggest, the transmission of a virus by email. The present invention relates to the application of that technique to the identification of spam including UBE, UCE and mail bombs.

According to the present invention there is provided a method of processing email which comprises monitoring email traffic passing through one or more nodes of a network for patterns of email traffic which are indicative of, or suggestive of, a mailshot of unsolicited or unwanted email and, once such a pattern is detected, initiating automatic remedial action, alerting an operator, or both.

The invention also provides a system for processing email which comprises means for monitoring email traffic passing through one or more nodes of a network for patterns of email traffic which are indicative of, or suggestive of a mailshot of unsolicited or unwanted email and once such a pattern is detected, initiating automatic remedial action, alerting an operator, or both.

Other, optional, features of the invention are defined in the sub-claims.

This system thus provides a way of identifying and stopping such unwanted mail by traffic analysis of mail at the network level in particular but not exclusively the Internet level. However, this can also be scaled down to scan at the ISP level, or even at a single company or mailserver if desired. However, it is most useful when done at a multi-ISP, multi country level.

As applied to the Internet, the scanning of traffic in our British Patent Application No. 0016835 has been referred to by the expression “scanning in the sky”, the “sky” alluding to the metaphorical Internet “cloud” often used in illustrations of the Internet. This expression is equally applicable to the present invention.

In the present invention, each mail is analysed primarily at the container level, and if likely to be spam, logged. If similar emails are detected, then the system eventually determines the emails are in fact spam, and all future matching emails are stopped. The actual cut-off point for determining when to stop emails depends both on the ‘likely-to-be-spam’ score and the number of emails received. Thus, some spam may be stopped at the first email. Others may take 10s or 100s. The system can be tuned so that the detection rate improves, and so that the system adapts to match changing behaviour of spammers.

The invention will be further described by way of non-limitative example with reference to the accompanying drawings, in which:—

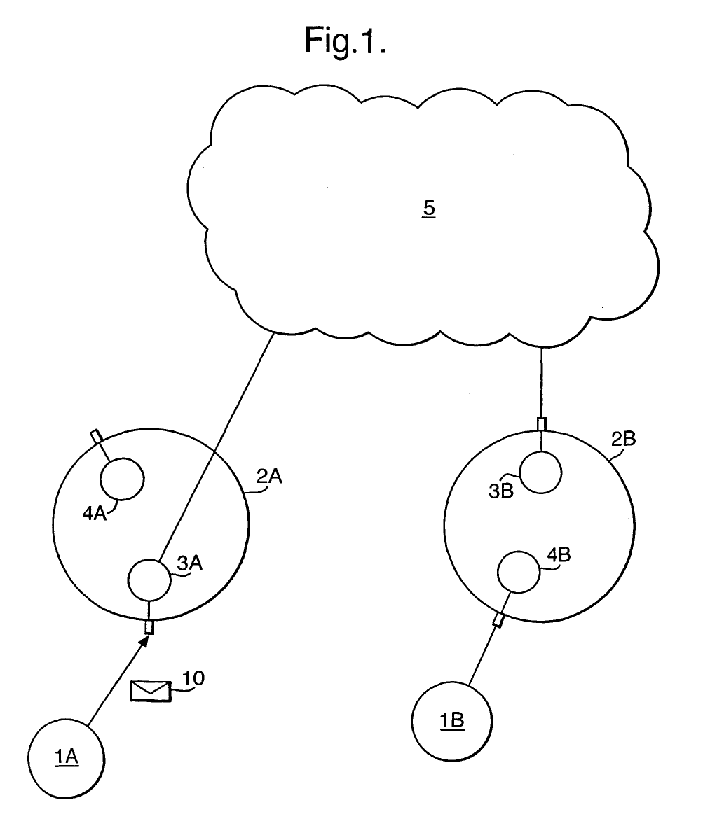

FIG. 1 illustrates the process of sending an email over the Internet; and

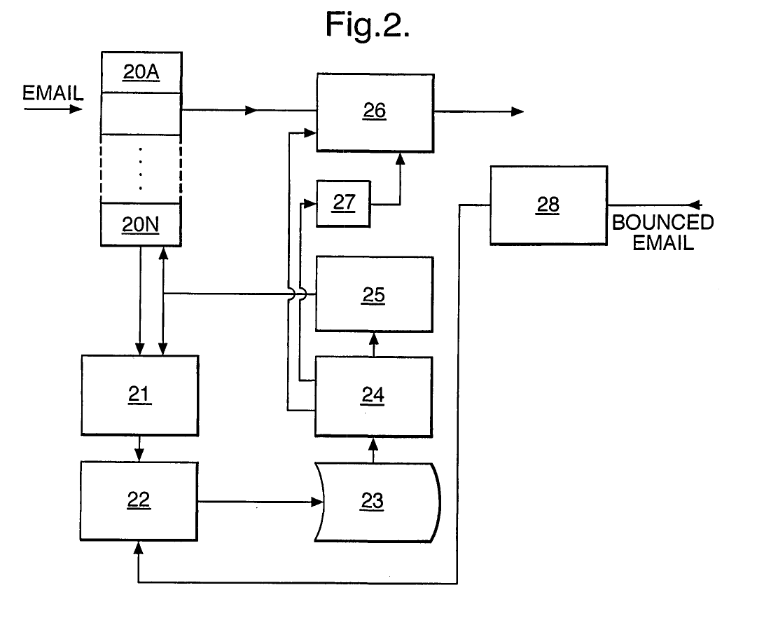

FIG. 2 is a block diagram of one embodiment of the invention.

Before describing the illustrated embodiment of the invention, a typical process of sending an email over the Internet will briefly be described with reference to FIG. 1. This is purely for illustration; there are several methods for delivering and receiving email on the Internet, including, but not limited to: end-to-end SMTP, IMAP4 and UCCP. There are also other ways of achieving SMTP to POP3 email, including for instance, using an ISDN or leased line connection instead of a dial-up modem connection.

Suppose a user 1A with an email ID “asender” has his account at “asource.com” wishes to send an email to someone 1B with an account “arecipient” at “adestination.com”, and that these .com domains are maintained by respective ISPs (Internet Service Providers). Each of the domains has a mail server 2A,2B which includes one or more SMTP servers 3A,3B for outbound messages and one or more POP3 servers 4A,4B for inbound ones. These domains form part of the Internet which for clarity is indicated separately at 5. The process proceeds as follows:

1. A sender prepares the email message using email client software 1A such as Microsoft Outlook Express and addresses it to “arecipient@adestination.com”.

2. Using a dial-up modem connection or similar, asender's email client 1A connects to the email server 2A at “mail.asource.com”. 3. Asender's email client 1A conducts a conversation with the SMTP server 3A, in the course of which it tells the SMTP server 3A the addresses of the sender and recipient and sends it the body of the message (including any attachments) thus transferring the email 10 to the server 3A.

4. The SMTP server 3A parses the TO field of the email envelope into a) the recipient and b) the recipient's domain name. It is assumed for the present purposes that the sender's and recipients' ISPs are different, otherwise the SMTP server 3A could simply route the email through to its associated POP3 server(s) 4A for subsequent collection.

5. The SMTP server 3A locates an Internet Domain Name server and obtains an IP address for the destination domain's mail server.

6. The SMTP server 3A connects to the SMTP server 3B at “adestination.com” via SMTP and sends it the sender and recipient addresses and message body similarly to Step 3.

7. The SMTP server 3B recognises that the domain name refers to itself, and passes the message to “adestination”'s POP3 server 4B, which puts the message in “arecipient”'s mailbox for collection by the recipients email client 1B.

Referring now to FIG. 2, this shows in block form the key sub-systems of an embodiment of the present invention. In the example under consideration, i.e. the processing of email by an ISP, these subsystems are implemented by software executing on the ISP's computer(s). These computers operate one or more email gateways 20A . . . 20N passing email messages such as 10.

The various subsystems of the embodiment will be described in more detail later, but briefly comprise:

A message decomposer/analyser 21, which decomposes emails into their constituent parts, and analyses them to assess whether they are candidates for logging;

A logger 22, which prepares a database entry for each message selected as a logging candidate by the decomposer/analyser 21;

A database 23, which stores the entries prepared by the logger 22;

A searcher 24, which scans new entries in the database 23 searching for signs of spam traffic;

A stopper 25, which signals the results from the searcher 24 and optionally stops the passage of emails which conform to criteria of the decomposer/analyser 21 as indicating unwanted mail;

A mail queuing system 26 (optional) for queuing email while it is processed by the above times, prior to delivering or forwarding;

A purger 27 (optional) which purges queued mail matching stop signatures;

A bounce analyser 28 (optional) which logs mail that bounces to the database.

The message decomposer/analyser 21 decomposes emails into their constituent parts, and analyses them to assess whether they are candidates for logging. The analyser may also perform more detailed analysis of particular messages following feedback from the stopper 25.

The illustrated embodiment applies a set of heuristics to identify potential spam. The following is a non-exhaustive list of criteria by which emails may be assessed in order to implement these heuristics. Other criteria may be used as well or instead.

1. It is Addressed to Many Recipients.

The addresses can be determined by parsing fields, such as To, Cc and Bcc in the email header and by analysing the email envelope. The number of addresses can simply be counted.

2. It is Addressed to Recipients or Organisations in a) Alphabetical or b) Reverse Alphabetical Order.

Once the addresses have been extracted as per Item 1 above, it is a simple matter to determine whether they are in any of these orders. Any ordering suggests that the addressee list was derived from a mailing list, possibly of the sort commonly used to generate bulk emails.

3. It Contains Structural Quirks

Most emails are generated by tried and tested applications. These applications will always generate email in a particular way. It is often possible to identify which application generated a particular email by examining the email headers and also be examining the format of the different parts. It is then possible to identify emails which contain quirks which either indicate that the email is attempting to look as if it was generated by a known emailer, but was not, or that it was generated by a new and unknown mailer, or by an application (which could be a virus or worm). All are suspicious.

### EXAMPLES

Inconsistent Capitalisation

from: alex@star.co.uk

To: alex@star.co.uk

The from and to have different capitalisation

Non-Standard Ordering of Header Elements

Subject: Tower fault tolerance

Content-type: multipart/mixed; boundary=“======_{—}962609498===_”

Mime-Version: 1.0

The Mime-Version header normally comes before the Content-Type header.

Missing or Additional Header Elements

X-Mailer: QUALCOMM Windows Eudora Pro Version 3.0.5 (32)

Date: Mon, 03 Jul. 2000 12:24:17+0100

Eudora normally also includes an X-Sender header

4. It Contains Unusual Message Headers

This would include headers that are rarely or never generated by normal email engines such as Outlook Notes or Eudora or where standard information is missing.

5. It Originates from Particular IP Addresses or IP Address Ranges.

The IP address of the originator is, of course, known and hence can be used to determine whether this criterion is met.

6. It Contains Specialised Constructs

Some email uses HTML script to encrypt the message content. This is intended to defeat linguistic analysers. When the mail is viewed in a mail client such as Outlook, the text is immediately decrypted and displayed. It would be unusual for a normal email to do this.

Some email uses HTML references to web pages to track whether the email has been read. It would be unusual for a normal email to do this.

7. The Text Body is Susceptible to Particular Linguistic Analysis.

Once the text body has been parsed out of the email it can be analysed and scored in a variety of ways, for example:

analysis by reference to established stylistic and content metrics, for example Gunning's Fog Index or Fry's Readability Graph. Analysis can establish whether the style indicates that it originated in the scientific community, the civil services, etc.

analysis to determine whether the message body contains certain keywords or keyphrases.

8. Empty Message Sender Envelopes

An email normally indicates the originator in the Sender text field and spam originators will often put a bogus entry in that field to disguise the fact that the email is spam. However, the Sender identity is also supposed to be specified in the protocol under which SMTP processes talk to one another in the transfer of email, and this criterion is concerned with the absence of the sender identification from the relevant protocol slot, namely the Mail From protocol slot.

9. Invalid Message Sender Email Addresses

This is complementary to item 8 and involves consideration of both the sender field of the message and the sender protocol slot, as to whether it is invalid. The email may come from a domain which does not exist or does not follow the normal rules for the domain. For instance, a HotMail address of “123@hotmail.com” is invalid because HotMail addresses cannot be all numbers.

A number of fields of the email may be examined for invalid entries, including “Sender”, “From”, and “Errors-to”.

10. Message Sender Addresses Which do not Match the Mail Server from Which the Mail is Sent.

The local mail server knows, or at least can find out from the protocol, the address of the mail sender, and so a determination can be made of whether this matches the sender address in the mail text.

11. Message has a Particular Container Format.

An email has a specific number of attachments (currently spam usually has no attachments) and specific encoding methods for its fields which can be assessed for their likelihood of indicating spam. Other similar characteristics which can be assessed include:

the “message boundary” which the email specifies in the header as a delimiter of subsequent fields of the message.

the “message ID” which is supposed to be a text string which uniquely identifies a particular instance of an email.

Bulk mail may contain the same message ID in some or all email instances.

Each of the above criteria is assigned a numerical score, and an algorithm is used by analyser 21 to determine whether this mail is a candidate for logging. This algorithm will need to evolve over time to track changes in spamming patterns. The intention is to weed out candidates for logging so that normal mail is not logged. This reduces the burden on the database 23, and improves performance. However, this step is not a requirement. The system will work perfectly well if all emails are logged. A simplistic algorithm would be:

If mail contains attachments, do not log (spam mail currently does not contain attachments).

If mail is over a certain size, do not log (spam mail is generally small, to keep the sender's overheads down).

If mail structure indicates it was generated by a common mail client, such as Outlook or Eudora, do not log (spam mail is generally generated by a specialist package).

Each UCE/Mailbomb package will construct the emails in a certain way, and by analysing the message container it is possible to identify the mail as being generated by either a particular package, or one of a series of packages, e.g. different release versions of the generator package.

The analyser also generates a series of values to enable the recognition of the email, or similar emails, if they recur. The values may include, but are not limited to:

The subject line, digest of subject line, digest of partial subject line.

Digest of text, digest of first, middle and last part of text.

Sender

Originating IP address

Path mail has taken

Structural format indicators

Structural quirk indicators

The digests may be of MD5 type, i.e. text strings derived using a one way hashing function from the field in question.

The logger 22 will log these to the database, together with other factors which may help future analysis, such as:

Number of recipients

Whether recipients are in alphabetical, or reverse alphabetical order

Time of logging

Linguistic analysis indicators

Message sender details

Old log entries are periodically deleted. Spam changes on a daily basis, and old log entries are no longer useful. As regards multi-tier logging, it is possible to contemplate embodiments in which email streams are analysed and processed at a number of sites, but with the logging, traffic analysis and spam identification centralised.

The searcher 24 periodically queries the database searching for recent similar messages and generating a score by analysing the components. Depending on the score, the system may identify a definite threat, or a potential threat. A definite threat causes a signature to be sent back to the stopper 25 so that all future messages with that characteristic are stopped. A potential threat can cause a signature to be sent back to the stopper 25 so that the next message with that characteristic is analysed in more detail, performing more time consuming linguistic analysis than before. A potential threat can also cause an alert to be sent to an operator, who can then decide to treat it as if it were a definite threat, to flag it as a false alarm so no further occurrences are reported, or to wait and see. The stopper 25 responds appropriately to the operator's instructions if action is necessary.

The following criteria can be used at the multiple email level:

They contain the same, or similar subject line

They contain the same or similar body text

They are addressed to many recipients

They are addressed to recipients in alphabetical, or reverse

alphabetical order

They contain the same structural format

They contain the same structural quirks

They contain the same unusual message headers

They originate from the same IP address, or IP address range

They contain specialised constructs

The body text is susceptible to linguistic analysis

Empty message sender envelopes

Invalid message sender email addresses

Message senders addresses which do not match the mail server from which the mail is arriving

Number of bounces of this email, and reason for bounce

They come from the same IP address, but have different sender addresses

The searcher 24 can be configured with different parameters, so that it can be more sensitive if searching logs from a single email gateway, and less sensitive if processing a database of world-wide information.

Each criterion can be associated a different score.

The time between searches can be adjusted.

The time span each search covers can be adjusted and multiple time spans accommodated.

Overall thresholds can be set

The stopper 25 takes signatures from the searcher 24. The signature identifies characteristics of emails which must be stopped, or which must be investigated further. On receiving a stop signature, all future emails matching this signature as detected by the analyser 21 are stopped. Current queued emails matching this signature are deleted by the purger. Old stopper signatures are periodically deleted.

On receiving an investigation signature, the next email that matches this signature is investigated more fully, and the signature then discarded. Depending on the time needed, this investigation need not interrupt the flow of mail—the mail in question can be copied and analysed either by a separate process on the mail server, or even on another machine. Since many mail servers may receive an email matching the signature at roughly the same time, the recommended approach is for these machines not to do the analysis themselves, but to copy the mail to another machine for analysis. This does not impact the flow of mail, and ensures that analysis work is not duplicated. If analysis work proves to be time-consuming, it is also recommended that the logger 22 flags that the particular mail is now under analysis. The stopper 25 can then update all the other mail servers so that they do not try and analyse the same email. The results of the analysis are then passed back to the logger 22.

The bounce analyser 28 signals to the logger 22 if an email cannot be delivered to the next mailserver in the delivering route. Normally, only emails which have already been flagged by the analyser 21 as ‘interesting’ need be logged. To make the system more sensitive, all emails may be logged. Only certain non-delivery conditions need be flagged. For instance, if the next mail server is not available, this is not interesting. However, it the mail server rejected mail because the recipient address was not valid, this is interesting.

The purger 27 (optional component) removes mail held in the mail queue at 26 and which has not been delivered yet, but which matches any stopper signatures.

Where the analyser 21 operates on emails in the live email stream (rather than on copies) the system may append text to the message body to indicate that the email has been scanned for spam. The system may also generate reports sent to end users, for example, indicating the number of messages blocked, or referring the user to retrieve them (assuming provision is made to temporarily store blocked emails).

1. A method of processing email which comprises monitoring email traffic passing through one or more nodes of a network for patterns of email traffic which are indicative of, or suggestive of, a mailshot of unsolicited or unwanted email and, once such a pattern is detected, initiating automatic remedial action, alerting an operator, or both.

2. A method according to claim 1 which comprises decomposing each email into its constituent parts, analysing one or more of the decomposed constituent parts for content taken to be indicative of that email belonging to such a mailshot and logging data of the decomposed email to a database.

3. A method according to claim 2, wherein data is logged only in respect of email which, on analysis, meets at least one criterion met by email belonging to such a mailshot.

4. A method according to claim 1, 2 or 3 and including the step of delivering, or forwarding for delivery, email not considered to belong to such a mailshot.

5. A method according to claim 2, 3 or 4 and including the step of continually or continuously executing an algorithm against entries in a database to identify patterns of email traffic taken to be indicative of, or suggestive of such a mailshot.

6. A method according to claim 5, wherein the database algorithm examines, principally or exclusively, only “recently” added database entries, i.e. entries which have been added less than a predetermined time ago.

7. A method according to any one of the preceding claims wherein the corrective action includes any or all of the following, in relation to each email which conforms to the detected pattern:
a) at least temporarily stopping the passage of the emails
b) notifying the intended recipient(s)
c) generating a signal to alert a human operator.

8. A system for processing email which comprises means for monitoring email traffic passing through one or more nodes of a network for patterns of email traffic which are indicative of, or suggestive of, a mailshot of unsolicited or unwanted email and once such a pattern is detected, initiating automatic remedial action, alerting an operator, or both.

9. A system according to claim 8 which comprises means for decomposing each email into its constituent parts, means for analysing one or more of the decomposed constituent parts for content taken to be indicative of that email being of such a mailshot and logging data of the decomposed email to a database.

10. A system according to claim 9 and including means for continually or continuously executing an algorithm against entries in the database to identify patterns of email traffic taken to be indicative of a mailshot of unsolicited emails.

11. A system according to claim 10, wherein the database algorithm examines, principally or exclusively, only “recently” added database entries, i.e. entries which have been added less than a predetermined time ago.

12. A system according to claim 9, 10, or 11, wherein data is logged only in respect of email which, on analysis, meets at least one criterion met by email belonging to such a mailshot.

13. A system according to claim 9, 10, 11, or 12 and including the step of delivering, or forwarding for delivery, email not considered to belong to such a mailshot.

14. A system according to any one of claims 8 to 13 wherein the corrective action includes any or all of the following, in relation to each email which conforms to the detected pattern:
a) at least temporarily stopping the passage of the emails
b) notifying the intended recipient(s)
c) generating a signal to alert a human operator.
